(19) United States
(12) Patent Application Publication
(10) Pub. No.: US 2003/0194584 A1
(43) Pub. Date: Oct. 16, 2003

(54) Mould resistant decorative panel

(76) Inventors: Arne Clausen, Toronto (CA); Bryce Clark, Bolton (CA)

Correspondence Address: Elias C. Borges, Suite 406, 1 Eva Road, Toronto, ON, M9C 4Z5, CA

(21) Appl. No.: 10/418,265

(22) Filed: Apr. 18, 2003

Related U.S. Application Data
(63) Continuation-in-part of application No. 09/732,652, filed on Dec. 5, 2000, now abandoned.

(51) Int. Cl. B05D 3/02; B27K 1/00; E04B 1/62; B27K 3/00; B27K 5/00

(52) U.S. Cl. 428/907; 427/389.8; 52/517

(57) ABSTRACT

The present invention is a decorative mould resistant gypsum wall board for use in constructing walls. The wall board is formed from a non-biodegradable gypsum wall board having opposite sides. The wall board has a water resistant gypsum core sandwiched between two glass fibre reinforced structural matts. A water vapour permeable decorative plastic sheet is bonded to one side of said gypsum wall board by a water vapour permeable adhesive layer. The water vapour permeable sheet may consist of a perforated sheet of decorative vinyl. The finished wall board is decorative, inherently mould resistant and will not act as a vapour barrier.

### CROSS REFERENCE TO RELATED APPLICATION

This is a Continuation-in-part of application Ser. No. 09/732,652 filed Dec. 5, 2000, the entirety of which is incorporated herein by reference.

### FIELD OF THE INVENTION

The invention relates generally to decorative gypsum wall panels of the type used to construct walls.

### BACKGROUND OF THE INVENTION

Gypsum wall boards used for constructing interior walls are well known. Traditional gypsum wall panel constructions generally consist of a plurality of gypsum cored wall panels (dry wall panels) mounted to wooden or metal wall frames. These wall panels are mounted to the frames in abutting end-to-end alignment and secured via nails or screws. The joint formed between two abutting wall panels is generally filled with a drywall compound and then finished to provide a smooth, flat surface. A decorative surface can then be applied to the inside surface of the wall panels by applying paint, stucco, or wallpaper.

While traditional gypsum wall panel constructions continue to be widely used in residential construction, the costs associated with this type of construction has limited its use in commercial applications. In commercial applications, partition walls are often re-arranged to suit the needs of the consumer. The labour intensive nature of traditional gypsum wall construction techniques makes re-configuring partition walls prohibitive. In response, modified wall panels have been developed which can be attached to a wall frame construction by means of clips or other attachment fasteners. These wall panels have relatively square side edges, so that when two panels are joined together in abutting relationship, the joint formed by the two abutting wall panels is relatively unobtrusive. To speed construction, these panels may have a decorative wallpaper pre-applied to one surface of the panel, thereby eliminating one step in the process of forming an internal partition wall.

While traditional and modular gypsum core wall panel construction remains very popular in both residential and commercial construction, these wall panel construction systems can, under certain circumstances, be prone to mould contamination. Essentially, moulds and other fungi can grow and spread within a wall construction if the relative humidity is high and if there is moisture present in the wall. Mould contamination can not only lead to a deterioration of the aesthetic appearance of the wall panels, it can actually pose a health risk. This is particularly a concern in schools where mould contamination can result in illness to both teachers and students. Once a wall construction has been contaminated by mould, the only truly effective means of eliminating the problem, is to remove the infected wall components. To minimize mould growth, water resistant coatings can be applied to gypsum wall panels in order to limit the buildup of moisture in the panels, and therefore retard the rate of mould growth. However, simply coating the wall panels with water resistant materials may not prevent mould contamination, since moisture can accumulate in these wall panels over time as a result of percolation (diffusion), defects in the coating or poor construction techniques.

Wall panels coated with a water resistant material have another drawback. The water resistant material coating the wall panel may act as a vapour barrier, causing the potential build up of condensation behind the wall panel. In cold climates, outside walls are usually constructed with a layer of insulation followed by a plastic vapour barrier attached to the inside surface of the outside wall. The plastic vapour barrier prevents warm moist air from inside the structure from moving into the outside wall, where it would condense and lead to moisture buildup. To finish the inside of the structure, a stud wall is constructed (usually from 2×4s) and mounted to the inside surface of the outside wall. Gypsum wall panels are then mounted to the stud wall. If the wall panels are also coated with a vapour barrier, then moist air may be trapped in the stud wall between the wall panels and the vapour barrier of the outside wall. Over time, this may lead to the accumulation of condensation in the stud wall and eventually the growth of mould.

In warm humid climates, outside walls are generally constructed with a vapour barrier on the outside surface of the outside wall. The outward facing vapour barrier prevents warm moist air from outside the structure from infiltrating into the airconditioned interior where it would condense. To finish the interior of these structures, a stud wall is erected on the inside surface of the outside wall and wall panels are attached to the inside surface of the stud wall. Again, if the wall panels have a vapour barrier coating, then moist air may be trapped between the inside stud wall and the outside vapour barrier, which may lead to condensation and mould growth.

The wall panels presently on the market do not address the problem of inhibiting mould growth and prevention of condensation. Therefore, there is a need for a wall panel which is both inherently resistant to mould growth and which prevents the conditions which leads to mould growth in walls.

### SUMMARY OF THE INVENTION

In accordance with the present invention, there is provided a decorative mould resistant gypsum wall board for use in constructing walls. The wall board is formed from a non-biodegradable gypsum wall board having opposite sides. A water vapour permeable decorative plastic sheet is bonded to one side of said gypsum wall board. The finished wall board is decorative, inherently mould resistant and will not act as a vapour barrier.

With the foregoing in view, and other advantages as will become apparent to those skilled in the art to which this invention relates as this specification proceeds, the invention is herein described by reference to the accompanying drawings forming a part hereof, which includes a description of the preferred typical embodiment of the principles of the present invention.

### BRIEF DESCRIPTION OF THE DRAWING

FIG. 1 is a cross-sectional view of a wall panel made in accordance to the present invention;

In the drawings like characters of reference indicate corresponding parts in the different figures.

### DETAILED DESCRIPTION OF THE PREFERRED EMBODIMENT

Traditional gypsum wall panels contain cellulose, either as a filler or as a structural material. Cellulose is a good growth medium for mould, therefore, cellulose/gypsum wall panels are prone to mould contamination. When exposed to prolonged periods of relatively high humidity, mould and fungus will grow on cellulose/gypsum wall panels. In particular, the mould will establish itself in the paper backing material used in the wall panel construction. Where the wall panel also has a decorative wallpaper treated surface, the mould will actually establish itself in the wallpaper. In addition, the adhesives used to adhere the paper backing to the gypsum core, and the adhesives used to adhere the wallpaper to the wall board may contain organic compounds which the mould may use as a food source. Therefore, merely treating the wall panel with a water resistant or waterproof coating is not sufficient. Over a period of years, moisture and humidity can make it's way through imperfections in any coatings. It is also believed that if even a portion of the panel core is exposed to water, the moisture will spread within the panel via percolation. Moulds can then establish themselves in the relatively moist wall panel and feed on the cellulose and other organic components used in the formation of the wall panel. Furthermore, treating the wall panel with a waterproof coating will cause the panel to act as a vapour barrier, preventing moisture from escaping the wall and potentially causing condensation to build up in the wall behind the wall panel. Therefore, applying a decorative plastic coating or sheet to a cellulose/gypsum wall board is not advisable because the plastic coating will act as a vapour barrier.

A wall panel may be made mould resistant if the wall panel does not have a medium upon which the mould can grow. In particular, the wall panel should not have any paper, cellulose, or other biodegradable material which can provide the mould with a food source. Additionally, antibiotic agents can be incorporated into the wall panel construction to ensure that any biodegradable contaminants which may make their way into the wall panel, either during the construction process or over a period of time as the product is used, will not foster the growth of mould. Also, to minimize the amount of moisture in the wall panel, and therefore minimize the amount of mould growth, the wall panel core should be as water resistant as possible. If the panel core is itself water resistant, then even if moisture should make contact with a portion of the wall panel core, the water resistant characteristics of the wall panel core will prevent the moisture from spreading. Finally, to allow for the evaporation of any moisture which may find its way into the wall panel, and to prevent the wall panel from acting as a vapour barrier, a vapour permeable decorative plastic sheet is bonded to one side of the wall panel by a non-biodegradable vapour permeable adhesive.

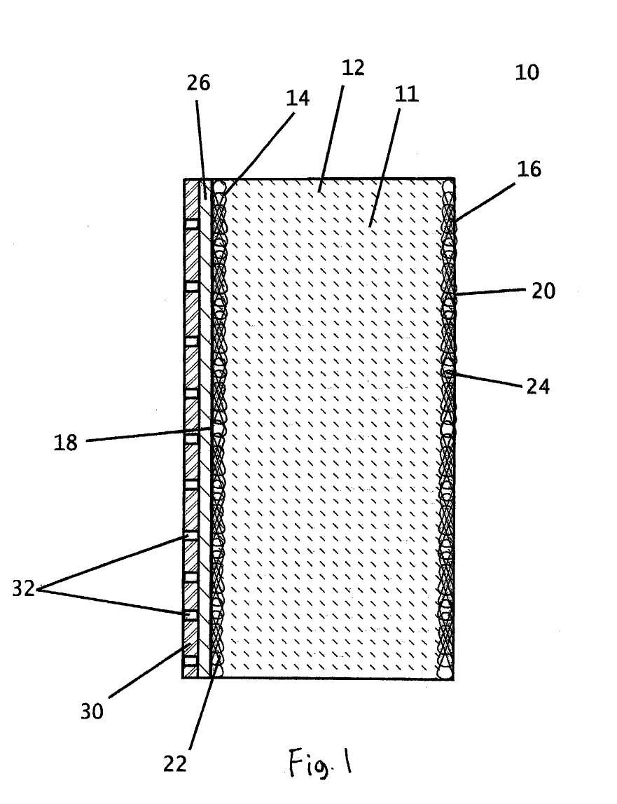

Referring firstly to FIG. 1, a wall panel made in accordance with the present invention is shown generally as item 10 and consists of a gypsum panel 11 having a core 12, opposite sides 14 and 16, opposite surfaces 18 and 20, and decorative vapour permeable vinyl layer 30 adhered to surface 18. Surfaces 18 and 20 are covered by non-biodegradable glass fibre matts 22 and 24. Vinyl layer 30 is adhered to surface 18 by adhesive layer 26, which consists of a layer of non-water vapour permeable biodegradable adhesive.

Preferably panel 11 consists of a non-combustible, water resistant gypsum core panel which is glass mat faced. Sides 14 and 16 of wall panel 11 are impregnated with numerous glass fibres 22 and 24, which extend into the interior of panel 11 and which cover surfaces 18 and 20, respectively. Surfaces 18 and 20 are preferably free of gypsum and covered by fibrous mats 22 and 24, respectively. Fibrous mats 22 and 24 provide structural strength to wall panel 11. While any gypsum wall board which consists of a gypsum core bonded between non-biodegradable structural matts may be used, the glass backed wall panel disclosed in U.S. Pat. No. 4,647,496 has been found to be particularly useful.

Vinyl sheeting 30 is adhered to surface 18 via adhesive layer 26. The adhesive comprising adhesive layer 26 consists of a non-biodegradable resin capable of adhering glass fibres to vinyl. It has been discovered that water based adhesives consisting of plasticizers, ethylene vinyl and acetate copolymers serve particularly well to bond decorative vinyl to glass backed gypsum wall panels.

Sheet 30 is preferably made of a flat sheet of non-biodegradable water resistant material such as vinyl and, when bonded to panel 11, forms a smooth, flat and water resistant surface. To permit water vapour to gradually pass thorough panel 11, vinyl sheeting 30 is made permeable by numerous perforations (pores) 32. Pores 32 are dimensioned to permit water vapour to pass through. Pores 32 are preferably about 1 mm or less in diameter. To ensure that the vinyl sheeting does not significantly inhibit the passage of moisture through the finished wall panel, the sheeting should have a sufficient “density” of perforations (i.e. pores per square centimetre). Appropriately perforated decorative vinyl sheeting is readily available in the marketplace. Preferably, the perforated vinyl sheeting should be selected to ensure that the overall permeability of the finished wall panel to water vapour approaches that of standard non-coated paper backed gypsum wall board.

While a woven material may be used for sheet 30, a perforated sheet of vinyl is preferred. Woven material tends to have a rough surface, which may trap dirt and dust, making the wall panel harder to clean. A smooth flat vinyl sheet, even if it is perforated, permits easier clean and less accumulation of dust and dirt than a woven sheet.

The type of adhesive used to bond the perforated vinyl sheeting to the wall panel is also a significant consideration. Water based adhesives are preferred since they permit the resin layer to be permeable to water vapour. Water based adhesives consisting of plasticizers, ethylene vinyl and acetate copolymers have been found to be effective in forming vapour permeable resin layers for binding the vinyl sheeting to glass backed gypsum wall boards. Several suitable water based adhesives are readily available in the marketplace.

It has been discovered that a perforated vinyl sheeting together with the vapour permeable adhesive layer will prevent the finished wall panel 11 from acting as a vapour barrier. The permeability of a material to water vapour (permeance) is generally measured in perms (grains/ft²-hr). A material having a permeance of less than 1.0 is considered a vapour barrier. For example, 4 mil polyethylene has a permeance of 0.08. Standard paper backed gypsum wall panels having no vinyl coating will generally have a permeance of about 49.7 perms. If these same wall panels are coated with a non-porous vinyl sheeting, then the effective water vapour permeance of the resulting wall panel will be between about 0.05 to 0.08. With a vapour permeance this low, the wall panel effectively acts as a vapour barrier. It has been discovered that a wall panel made in accordance with the present invention will have an effective water vapour permeance of 38.8 perms as measured in accordance with the ASTM E 96-94, Procedure A Desiccant method. This is a similar level of water vapour permeance to standard cellulose/gypsum wall panels.

The use of a vinyl decorative sheeting instead of wallpaper minimizes the likelihood that mould will grow on the panel surface since the vinyl sheeting is not biodegradable. The addition of an antibiotic agent to the sheeting further decreases the possibility of mould growth in the wall panel. Using a glass fibre backed water resistant gypsum wall panel also minimizes the growth of mould. The combined use of a non organic decorative vinyl face, adhesive and glass fibre reinforced water resistant gypsum panel will not grow mould, even in highly humid conditions. Simply applying a water vapour permeable vinyl sheet and resin layer to a standard cellulose/gypsum wall panel is not advisable, particularly for use in highly humid climates because the resulting panel could actually absorb moisture from the air. This absorbed moisture will promote mould growth in the cellulose/gypsum wall panels. Simply adding an antibiotic agent to these cellulose/gypsum wall panels will not be sufficient to prevent mould growth, since the antibiotic gradually loses effectiveness and since the cellulose in these panels is an abundant growth medium for the mould. The non-biodegradable, water resistant glass backed gypsum wall boards as used in the present invention do not foster mould growth because they have no organic medium upon which the mould can grow. Due to its lack of an organic growth medium, even a relatively small amount of antibiotic agent used in these panels is sufficient to prevent any mould growth from occurring. Therefore, any moisture retention in the wall panels resulting from the water vapour permeable vinyl sheeting and resin layer will not pose a mould growth problem.

A method of constructing the wall panels will now be discussed. Essentially, the method consists of applying a layer of adhesive resin to one side of the vinyl sheet, and then applying the resin coated sheet to the surface of the gypsum wall panel. The vinyl sheet is then pressed against the gypsum wall panel to smooth out any wrinkles in the sheet and to ensure that the adhesive layer is well bonded to the surface of the gypsum wall panel. The laminated wall panel is then held at room temperature to permit the adhesive to cure. The wall panel and vinyl sheet and both held at room temperature during the lamination process to reduce the risk of shrinkage during the curing period. The curing period will depend on the adhesive used, but for most water based ethylene vinyl adhesives, the curing period will be several minutes. The lamination process is preferably carried out in a laminating machine. Vinyl laminating machines are readily available in the marketplace. These laminating machines usually apply the adhesive to one side of a continuous roll of vinyl and then press the coated vinyl to the wall panel via a series of rollers.

The mould resistance of the wall panels made in accordance with the present invention were tested. Three wall panel samples made in accordance with the present invention were tested in accordance with ASTM Specification G 26-1996. The following organisms were used in the test, namely Aspergillius Niger, Penicillium Pinophilum, Chaetomium Globosum, Oliocladium Virens and Aureobasidium Pullans. Method 508 for fungus and mould resistance was used. An incubation time of 28 days was used, and a 42× microscope was used to determine fungus growth. After 28 days of incubation, no fungus growth was observed.

A specific embodiment of the present invention has been disclosed; however, several variations of the disclosed embodiment could be envisioned as within the scope of this invention. It is to be understood that the present invention is not limited to the embodiments described above, but encompasses any and all embodiments within the scope of the following claims.

1. A decorative mould resistant gypsum wall board for use in constructing walls, said wall board comprising a non-biodegradable gypsum wall board having opposite sides and a water vapour permeable decorative plastic sheet bonded to at least one side of said gypsum wall board.

2. A decorative mould resistant gypsum wall board as defined in claim 1 wherein the vapour permeable decorative plastic sheet is bonded to the gypsum wall board by a water vapour permeable bonding layer.

3. A decorative mould resistant gypsum wall board as defined in claim 2 wherein the plastic sheet is perforated by a plurality of pores.

4. A decorative mould resistant gypsum wall board as defined in claim 3 wherein the pores have a diameter of less than about one millimeter.

5. A decorative mould resistant gypsum wall board as defined in claim 1 wherein the non-biodegradable gypsum wall board consists of a water resistant gypsum core between two fibreglass structural mats.

6. A decorative mould resistant gypsum wall board as defined in claim 1 wherein the non-biodegradable gypsum wall board further includes an antibiotic agent incorporated into the wall board.

7. A decorative mould resistant gypsum wall board as defined in claim 2 wherein the bonding layer is formed from a water based adhesive.

8. A decorative mould resistant gypsum wall board as defined in claim 7 wherein the water based adhesive comprises a mixture of a plasticizer, ethylene vinyl and an acetate copolymer.

9. A decorative mould resistant gypsum wall board for use in constructing walls, said wall board comprising a non-biodegradable gypsum wall board having opposite sides, the non-biodegradable gypsum wall board having a water resistant gypsum core between two fibreglass structural mats, a water vapour permeable decorative plastic sheet bonded to one side of said gypsum wall board by a water vapour permeable bonding layer.

10. A decorative mould resistant gypsum wall board as defined in claim 9 wherein the plastic sheet is perforated by a plurality of pores, each pore dimensioned to permit water vapour to pass there through.

11. A decorative mould resistant gypsum wall board as defined in claim 10 wherein the pores are less than about 1 millimetre in diameter and wherein the sheet is bonded to the gypsum wall board by an adhesive made from an aqueous mixture of a plasticizer, ethylene vinyl and an acetate copolymer.

12. A decorative mould resistant gypsum wall board as defined in claim 11 wherein the wall board further comprises an antibiotic agent incorporated into the non-biodegradable gypsum wall board.

13. A decorative mould resistant gypsum wall board for use in constructing walls, said wall board comprising a non-biodegradable gypsum wall board having opposite sides, the non-biodegradable gypsum wall board having a water resistant gypsum core between two fibreglass structural mats, a decorative plastic sheet bonded to at least one side of said gypsum wall board, said plastic sheet being made substantially water vapour permeable by a plurality of pores, said pores being less than about 1 millimetre in diameter, said sheet being bond to the wall board by a water vapour permeable bonding adhesive made from an aqueous mixture of a plasticizer, ethylene vinyl and an acetate copolymer.
